(19) United States
(12) Patent Application Publication
(10) Pub. No.: US 2024/0047781 A1
(43) Pub. Date: Feb. 8, 2024

(54) BATTERY PACK AND VEHICLE

(71) Applicant: HONDA MOTOR CO., LTD., Tokyo (JP)

(72) Inventors: Yaozhong Huo, Guangzhou (CN); Yang Li, Guangzhou (CN); Jianhua Yu, Guangzhou (CN); Jian Li, Guangzhou (CN)

(21) Appl. No.: 18/228,712

(22) Filed: Aug. 1, 2023

(30) Foreign Application Priority Data
Aug. 4, 2022 (CN) 202210931465.3

(51) Int. Cl. H01M 10/6556; H01M 10/625; H01M 10/658

(52) U.S. Cl. CPC H01M 10/6556; H01M 10/625; H01M 10/658; H01M 2220/20

(57) ABSTRACT

A battery pack comprising: a housing and a battery provided in the housing, the housing provided with a heat exchange agent flow-path; the battery comprising a battery module provided with at least two battery cores arranged in parallel; the heat exchange agent flow-path comprising at least two branches, each branch being located at one side of each battery core; wherein the width direction of the branches is the same as the width direction of the battery cores, and which the width of the battery cores is defined is X and the width of the branches is defined as Y, 0.5X≤Y<X.

### CROSS-REFERENCE TO RELATED APPLICATION

Priority is claimed on Chinese Patent Application No. 202210931465.3, filed on Aug. 4, 2022, the contents of which are incorporated herein by reference.

### BACKGROUND OF THE INVENTION

### Field of the Invention

The present invention relates to a vehicle battery pack and vehicle.

### Description of Related Art

An onboard battery is used to provide the electrical energy needed to run an electric vehicle. However, the performance of the battery in providing electrical energy for the electric vehicle is greatly affected by the temperature. If the temperature of the battery is too high, it may affect the life of the battery and may even cause a safety incident. If the temperature of the battery is too low, it will seriously affect the performance of the battery, which in turn will affect the driving range of the electric vehicle.

In order to enable the battery to operate in its proper temperature range, heat exchange pipes are usually placed around the battery. The heat exchange agent in the heat exchange pipes is used to exchange heat with the battery, so that the temperature of the battery can be regulated. However, in order to obtain sufficient heat exchange power, it is usually necessary to inject a large amount of heat exchange agent into the heat exchange pipes, which will increase the weight of the vehicle and affect the driving range of the electric vehicle. In addition, the heat exchange efficiency between the heat exchange pipes and the battery, as well as the temperature regulation effect of the heat exchange pipes on the battery, is easily affected by such factors as the layout of the heat exchange pipes and the flow rate of the heat exchange agent. Therefore, methods of reducing the amount of heat exchange agent, achieving light weight, as well as improving the heat exchange efficiency and the temperature regulation effect of the battery, have become the goal of research.

### SUMMARY OF THE INVENTION

In view of the above problems of the prior art, this application provides a battery pack and a vehicle in which a battery obtains enough heat exchange power while light weight is achieved.

The first aspect of this application provides a battery pack comprising: a housing and a battery provided in the housing; the housing provided with a heat exchange agent flow-path; the battery comprising a battery module provided with at least two battery cores arranged in parallel; the heat exchange agent flow-path comprising at least two branches, each branch being located at one side of each battery core; wherein the width direction of the branches is the same as the width direction of the battery cores; and when the width of the battery cores is defined as X and the width of the branches is defined as Y, 0.5X≤Y<X.

From the above, by setting the width of the branches to be greater than or equal to half the width of the battery cores, it is possible to obtain a sufficient contact area between the branches and the battery cores, and at the same time ensure that there is enough heat exchange agent in the branches so that the heat exchange with the battery cores can be achieved quickly. Consequently, the heat exchange agent flow-path can meet the power requirement of heat exchange of battery. In addition, by setting the width of the branches 115 to be smaller than the width of the battery cores 211, it is possible to prevent the width of the branches 115 from becoming too large and exceeding the width of the battery cores 211, which would prevent some of the heat exchange agent in the branches 115 from participating in the heat exchange of the battery cores 211. Accordingly, it is possible to avoid adding excess weight and wasting the heat exchange power of the heat exchange agent flow-path 110, and achieve light weight.

As a possible embodiment of realizing the first aspect, the width of the battery cores and the width of the branches are defined as 0.5X≤Y≤0.6X.

From the above, a more preferred width range of the branches is provided, thus enabling the battery to obtain sufficient heat exchange power while further achieving lighter weight.

As a possible embodiment of realizing the first aspect, within the battery module, each of the battery cores is arranged in parallel along its own width direction; and the length direction of the battery cores is the same as the length direction of the housing.

Since the space available for the battery pack in a vehicle is limited, the space available for mounting the battery in the housing is thus restricted. By keeping the length direction of the battery cores the same as the length direction of the housing, the utilization of space is improved and a more compact battery pack structure can be obtained.

As a possible embodiment of realizing the first aspect, when the height of the branches is defined as h, 2.1 mm≤h≤3.1 mm.

From the above, a preferred range of heights of the branches is provided so that it is possible to reduce the weight of the heat exchange agent in the heat exchange agent flow-path while also reducing the pressure loss of the heat exchange agent in the heat exchange agent flow-path and obtaining a good heat exchange coefficient.

As a possible embodiment of realizing the first aspect, the width of each branch is the same.

From the above, it is possible to make the pressure loss of the heat exchange agent more uniform between different branches by setting the widths between the different branches to be the same, thus avoiding the pressure loss of the heat exchange agent in the heat exchange agent flow-path to be increased due to the excessive pressure loss in one branch. At the same time, by setting the width between the branches to be the same, the flow rate of the heat exchange agent in each branch can also be made more uniform, which will lead to a more uniform regulation rate of the battery temperature and enhance the temperature regulation effect.

As a possible embodiment of realizing the first aspect, the branches extend in the length direction of the battery cores.

From the above, since the length dimension of the battery cores is larger than the width dimension thereof, the branches extend in the length direction of the battery cores, which can shorten the length of the heat exchange agent flow-path at the turning position compared to the branches extending along the width of the battery cores or in another direction. Consequently, the length of the heat exchange agent flow-path can be shortened, thereby reducing the pressure loss of the heat exchange agent and achieving light weight.

As a possible embodiment of realizing the first aspect, the heat exchange agent flow-path comprises a first flow section and a second flow section, the first flow section and the second flow section each comprising at least two branches, at least two of the branches being spaced apart and arranged in parallel.

From the above, by providing at least two branches in the first flow section and the second flow section in parallel, it is possible to adjust the temperature of the battery at the location where the temperature needs to be adjusted more precisely by each branch. Meanwhile, it is also possible to reduce the heat exchange agent at the position where there is no temperature regulation demand, thereby reducing the amount of heat exchange agent passed into the heat exchange agent flow-path, which in turn reduces the overall weight of the vehicle and achieves light weight.

As a possible embodiment of realizing the first aspect, the housing is provided with a mounting position between the two branches; and the branches are provided with a deflecting bend in the form of an arc to avoid the mounting position.

From the above, when there is a mounting position between the branches, it is possible to cause the branches to avoid the mounting position by providing a deflecting bend in the branches. As a result, the influence between the branches and the mounting position can be reduced.

As a possible embodiment of realizing the first aspect, the farther a branch is from the mounting position, the smaller the curvature of the deflecting bend in the branch is.

From the above, by setting the curvature of the deflecting bend in the branch farther away from the mounting position to be smaller, it is possible to make the width of the deflecting bend in different branches more uniform, and thus make the pressure loss of the heat exchange agent more uniform between different branches to enhance the temperature regulation effect. Meanwhile, it is also possible to reduce the width change of the branches in the deflecting bend, so as to reduce the pressure loss of the heat exchange agent in the branches.

As a possible embodiment of realizing the first aspect, the heat exchange agent flow-path has a heat exchange agent inlet and a heat exchange agent outlet, with one end of the first flow section communicated with the heat exchange agent inlet via an inflow cavity, and one end of the second flow section communicated with the heat exchange agent outlet via an outflow cavity.

From the above, the heat exchange agent provided by the heat exchange agent inlet can be delivered to each branch in a dispersed manner through the inflow cavity, and the heat exchange agent in each branch can be discharged from the heat exchange agent outlet after convergence through the outlet cavity. From this, it is possible to reduce the pressure loss of the heat exchange agent and improve the temperature regulation efficiency of the heat exchange agent.

As a possible embodiment of realizing the first aspect, the heat exchange agent inlet is positioned further up than the first flow section, and the inflow cavity has a gradually increasing cross-sectional area in the horizontal direction from top to bottom;
and/or the heat exchanging outlet is positioned further up than the second flow section, and the outflow cavity has a gradually decreasing cross-sectional area in the horizontal direction from bottom to top.

From the above, by setting the heat exchange agent inlet above the first flow section and the heat exchange agent outlet above the second flow section, it is possible to avoid collisions between the heat exchange agent inlet and the heat exchange agent outlet and the pipes connected to them and objects appearing below the housing, reducing the chance of leakage due to collisions. Thus, the protective structure for the heat exchange agent inlet and the heat exchange agent outlet can be reduced and the structural strength of the housing can be enhanced. By setting the cross-sectional area of the inflow cavity in the horizontal direction to gradually increase from top to bottom, the heat exchange agent flowing in the inflow cavity is guided so that the heat exchange agent flows in a diffuse manner in the inflow cavity toward each branch. By setting the cross-sectional area of the outflow cavity in the horizontal direction to gradually decrease from bottom to top, the heat exchange agent flowing in the outflow cavity is guided so that the heat exchange agent gradually converges as it flows in the outflow cavity toward the heat exchange agent outlet to allow the heat exchange agent to be discharged from the heat exchange agent outlet. Thus, the pressure loss of the heat exchange agent in the inflow cavity and the outflow cavity is reduced, the flow of the heat exchange agent is facilitated, and the temperature regulation effect is enhanced.

As a possible embodiment of realizing the first aspect, the first flow section and the second flow section are form a U-shaped structure.

From the above, by forming a U-shaped structure of the first flow section and the second flow section, the number of turns of the heat exchange agent can be reduced. In turn, the pressure loss of the heat exchange agent can be reduced and the temperature regulation effect can be enhanced.

As a possible embodiment of realizing the first aspect, the heat exchange agent flow-path further comprises: a fluxion cavity communicating the other end of the first flow section with the other end of the second flow section. The first flow section and the second flow section together form the U-shaped structure by being connected to the fluxion cavity.

From the above, the heat exchange agent in the plurality of branches of the first flow section can converge in the fluxion cavity and be delivered by the fluxion cavity to the plurality of branches in the second flow section. As a result, the pressure loss caused by the transfer of the heat exchange agent from the first flow section into the second flow section by dividing it into at least two branches for delivery can be reduced, and thus the temperature regulation effect can be enhanced.

As a possible embodiment of realizing the first aspect, the fluxion cavity is provided with an inferior arc-shaped cross section in the horizontal direction on the side of the fluxion cavity away from the first flow section and the second flow section.

From the above, by setting the fluxion cavity in an inferior arc shape, the heat exchange agent in the fluxion cavity can be guided, thus reducing the pressure loss of the heat exchange agent in the fluxion cavity. Accumulation of some heat exchange agent in the fluxion cavity that cannot participate in the regulation of the battery temperature can also be avoided, thus enhancing the temperature regulation efficiency of the heat exchange agent. In addition, the inferior arc-shaped fluxion cavity can reduce the volume of the fluxion cavity compared with a semi-circular or major arc-shaped fluxion cavity, which can make the housing more compact.

As a possible embodiment of realizing the first aspect, the fluxion cavity is provided with a trapezoidal cross-sectional shape in the horizontal direction with the bottom edge of the trapezoid provided on the side close to the first flow section and the second flow section and the top edge of the trapezoid away from the first flow section and the second flow section.

Since the length of the top edge of the trapezoid is smaller than the length of the bottom edge, by setting the cross-sectional shape of the fluxion cavity in the horizontal direction to a trapezoid, it is possible to make the coolant in the first flow section enter the fluxion cavity from the bottom edge of the trapezoid near one side, and then the coolant can flow into the second flow section from the bottom edge of the trapezoid near the other side under the guidance of both sides of the trapezoid and the top edge. As a result, the pressure loss of coolant in the fluxion cavity can be reduced and some of the heat exchange agent can be prevented from stagnating in the fluxion cavity. Meanwhile, the trapezoidal structure can achieve the same effect of reducing the volume of the fluxion cavity and making the housing structure more compact compared with the cavity of a semi-circular structure or major arc structure.

As a possible embodiment of realizing the first aspect, the housing comprises: a lower housing and a base plate; the base plate is mounted on the lower housing, and the heat exchanging flow-path is formed between the base plate and the lower housing.

From the above, a heat exchange agent flow-path is formed between the base plate and the lower housing, so that components such as a heat exchange agent tube for a heat exchange agent to flow through can be dispensed with independently. As a result, the structure of the housing can be simplified, the weight of the housing can be reduced, and light weight can be achieved. Meanwhile, it is possible to reduce the number of parts of the housing, reduce assembly steps and assembly time, and improve assembly efficiency.

As a possible embodiment of realizing the first aspect, the base plate is provided with at least two bumps protruding towards the lower housing; and the bumps are positioned in one-to-one correspondence with the battery cores.

From the above, the structural strength of the base plate at the corresponding position of the battery cores can be improved by providing bumps on the base plate. As a result, under the premise of meeting the strength requirements of the base plate, the thickness and weight of the base plate can be reduced, and the weight of the housing can be reduced to achieve light weight. In addition, when a milling cutter is required to process the surface of the base plate towards the battery cores, only the top surfaces of the bumps need to be processed, thus reducing the workload of milling cutter processing and increasing the processing speed.

As a possible embodiment of realizing the first aspect, the lower housing is connected to the battery by means of a heat transfer adhesive.

From the above, it is possible to enhance the heat exchange between the lower housing and the battery module by providing a heat transfer adhesive between the lower housing and the battery module, thus improving the temperature regulation effect.

As a possible embodiment of realizing the first aspect, a heat insulation layer is further provided on the side of the base plate away from the lower housing.

From the above, by providing a heat insulation layer on the base plate, it is possible to reduce the influence of ambient temperature on the housing and the battery inside the housing.

As a possible embodiment of realizing the second aspect, a vehicle comprises a bodywork provided with a battery pack therein. The battery pack is any of the possible implementations of the battery pack in the first aspect of this application.

From the above, when the battery according to the first aspect is mounted in the vehicle, by setting the width of the branches to be greater than or equal to half the width of the battery cores, it is possible to obtain a sufficient contact area between the branches and the battery cores, and at the same time ensure that there is enough heat exchange agent in the branches so that the heat exchange with the battery cores can be achieved quickly. Consequently, the heat exchange agent flow-path can meet the power requirement of heat exchange of the battery. In addition, by setting the width of the branches to be smaller than the width of the battery cores, it is possible to prevent the width of the branches from becoming too large and thus exceeding the width of the battery cores, in which case some of the heat exchange agent in the branches cannot participate in the heat exchange of the battery cores. Accordingly, it is possible to avoid adding excess weight and wasting the heat exchange power of the heat exchange agent flow-path, and achieve light weight.

As a possible embodiment of realizing the second aspect, the first flow section and the second flow section both extend along the length of the vehicle.

From the above, it is possible to make the first flow section and the second flow section extend in the same direction as the length direction of the battery cores when, for example, the length direction of the battery cores in the battery pack is the same as the length direction of the vehicle. The length size of the battery cores is larger than the width size, under the condition that the first flow section and the second flow section have the same contact area with the battery cores, when the first flow section and the second flow section extend in the length direction of the vehicle, compared to when the first flow section and the second flow section extend in the width direction of the vehicle, the length and width of the first flow section and the second flow section are smaller at the turning position when the first flow section and the second flow section extend in the length direction of the vehicle. As a result, the capacity of the heat exchange agent in the turning position of the first flow section and the second flow section can be reduced, and thus the weight of the battery pack and the vehicle can be reduced and light weight can be achieved.

These and other aspects of the present invention will be more succinctly understood from the description of the (plural) embodiment(s) below.

### BRIEF DESCRIPTION OF THE DRAWINGS

The various features of the present invention and the relationships between the various features will be further described below with reference to the accompanying drawings. The accompanying drawings are exemplary, some features are not shown to actual scale, and some of the accompanying drawings may omit features that are common in the field related to the present application and are not essential to the present application, or additionally show features that are not essential to the present application, and the combination of features shown in the accompanying drawings is not intended to limit the present application. In addition, the same reference symbols of the accompanying drawings are the same throughout the specification. The specific accompanying drawings are illustrated as follows:

FIG. 1 is a schematic diagram of one use scenario of the housing of a battery pack for a vehicle in an embodiment of the present application;

FIG. 2 is a schematic diagram of the structure of a battery pack in an embodiment of the present application;

FIG. 3 is a schematic diagram of the structure of the housing in FIG. 2;

FIG. 4 is a schematic diagram of the structure of the battery module in FIG. 2;

FIG. 5 is a schematic diagram of the heat exchange coefficient, pressure loss, and weight of the heat exchange agent in the heat exchange agent flow-path in FIG. 3 as a function of the height of the heat exchange agent path;

FIG. 6 is a schematic diagram of the side structure of the housing in FIG. 3;

FIG. 7 is a comparison diagram of a heat exchange agent flow-path extending in the length and width directions of the battery cores;

FIG. 8 is a schematic diagram of a comparative example of the flow direction of a heat exchange agent;

FIG. 9 is a schematic diagram for illustrating the shape of the heat exchange agent flow-path;

FIG. 10 is a schematic diagram of the fluxion cavity in an embodiment of the present application compared with other shapes of the fluxion cavity;

FIG. 11 is a schematic partial cross-sectional diagram of the housing in the vertical plane at the position of the heat exchange agent inlet and the heat exchange agent outlet in this embodiment of the present application;

FIG. 12 is a schematic diagram of the three-dimensional structure of the battery pack in an embodiment of the present application;

FIG. 13 is a schematic diagram of the structure of the housing in FIG. 12;

FIG. 14 is a disassembled schematic diagram of the housing in FIG. 12;

FIG. 15 is a schematic diagram of the structure of the lower housing in FIG. 14;

FIG. 16 is a schematic diagram of the structure of the base plate in FIG. 14;

FIG. 17 is a partial cross-sectional enlarged view of the battery pack in FIG. 12 at the corresponding positions of the battery cores;

FIG. 18 is a radial sectional view of the heat exchange agent inlet and the heat exchange agent outlet in FIG. 13; and

FIG. 19 is a schematic partial enlarged view of the inflow and outflow cavities in FIG. 13.

### BRIEF DESCRIPTION OF THE REFERENCE SYMBOLS

1 vehicle; 10 battery pack; 20 bodywork; 30 wheel; 100 housing; 110 heat exchange agent flow-path; 111 heat exchange agent inlet; 112 heat exchange agent outlet; 113 first flow section; 114 second flow section; 115 branch; 115a concave part; 116 inflow cavity; 117 outflow cavity; 118 fluxion cavity; 119 deflecting bend; 120 first mounting position; 130 lower housing; 131 protrusion bar; 132 mounting part; 140 base plate; 141 bump; 142 second mounting position; 200 battery; 210 battery module; 211 battery core.

### DETAILED DESCRIPTION OF THE INVENTION

The terms “first, second, third, etc.” or similar terms such as Module A, Module B, Module C, etc. are used herein only to distinguish similar objects and do not imply a particular ordering of objects, and it is understood that particular orders or sequences may be interchanged where permitted so that embodiments of the present application described herein can be implemented in an order other than that illustrated or described herein.

The term “comprise” and/or “include” and their variants as used herein should not be construed as limiting to what is listed thereafter, and it does not exclude other components. Accordingly, it should be interpreted as designating the presence of the described feature, entity or component mentioned, but does not exclude the presence or addition of one or more other features, entities or components and groups thereof. Thus, the expression “unit comprising parts A and B” should not be limited to a unit comprising only parts A and B.

References in this specification to “an embodiment” or “embodiments” mean that the particular feature, structure or characteristics described in conjunction with that embodiment are included in at least one embodiment of the present invention. Thus, the terms “in an embodiment” or “in embodiments” appearing throughout this specification do not necessarily refer to the same embodiment, but may refer to the same embodiment. In addition, in one or more embodiments, the particular features, structures, or characteristics can be combined in any suitable manner, as would be apparent from the present disclosure to one skilled in the art.

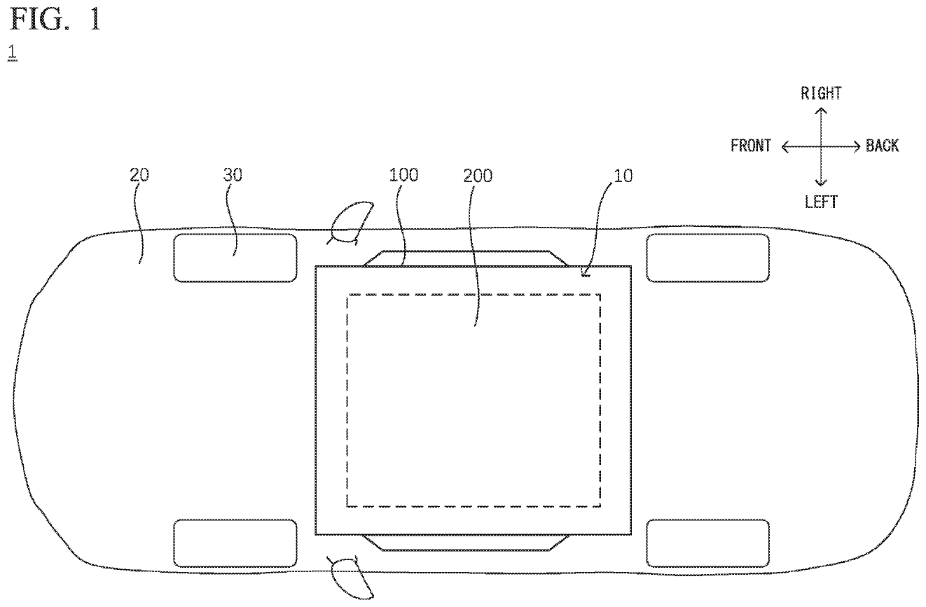

FIG. 1 is a schematic diagram of one use scenario of the housing 100 of a battery pack 10 for a vehicle 1 in an embodiment of the present application. FIG. 1 and the vehicle 1 herein are illustrative examples of electric vehicles and should not be considered as limitations of this application. The vehicle 1 can be an electric or hybrid vehicle, or any of the different types of vehicles such as a car, a truck, a passenger bus, or a sport utility vehicle (SUV). The vehicle 1 can also be a tricycle, a two-wheeled vehicle, a train or other land transportation means for carrying people or cargo.

As shown in FIG. 1, the vehicle 1 in this application includes a bodywork 20, wheels 30, and a battery pack 10, among other items. The wheels 30 are provided at the underside of the bodywork 20, and the wheels 30 rotate so as to drive the vehicle 1 to move. The battery pack 10 is provided in the bodywork 20, specifically, in the middle of the underside of the bodywork 20, or at any other suitable location. The battery pack 10 includes a housing 100 and a battery 200, the battery 200 being mounted in the housing 100 and providing the electrical energy required by the vehicle 1.

Hereinafter, the specific structure of the battery pack 10 in this embodiment of the application will be described in detail in conjunction with the accompanying drawings.

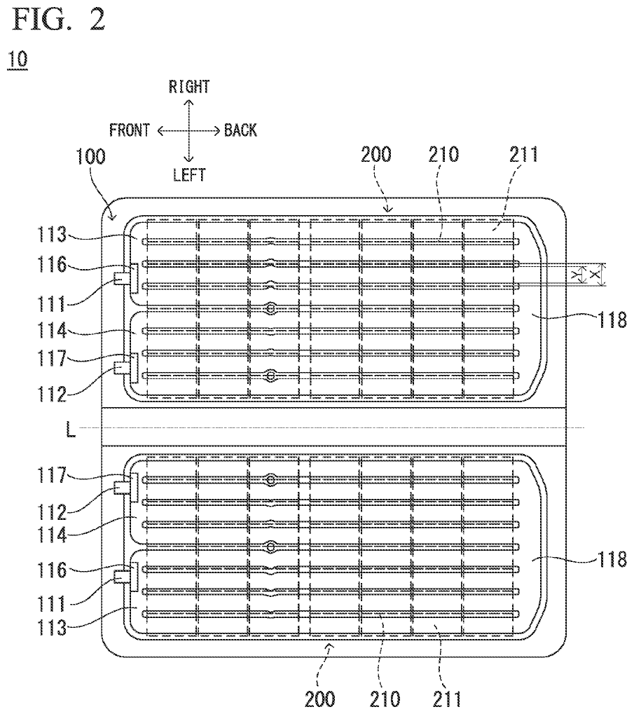

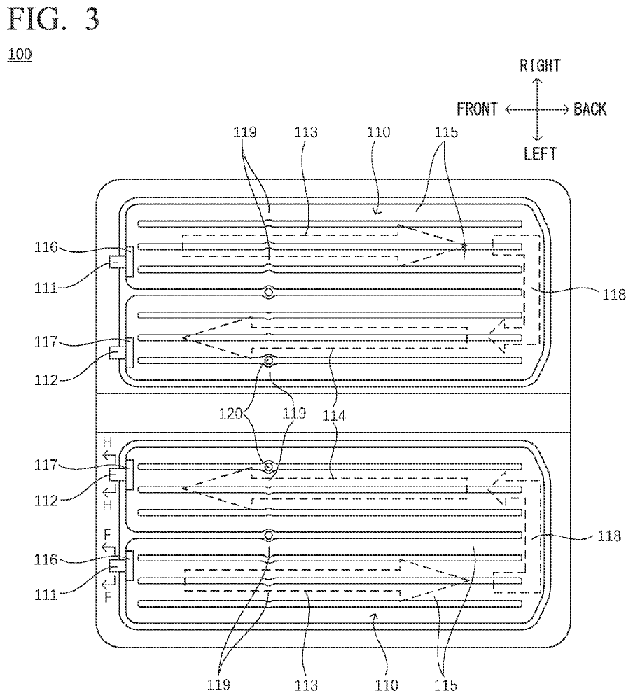

FIG. 2 is a schematic diagram of the structure of a battery pack in an embodiment of the present application. FIG. 3 is a schematic diagram of the structure of the housing in FIG. 2. As shown in FIGS. 2 and 3, the battery pack 10 in this application includes a housing 100 and a battery 200 provided in the housing 100, wherein the housing 100 is provided with heat exchange agent flow-paths 110. The battery 200 comprises battery modules 210 provided with at least two battery cores 211 arranged in parallel; the heat exchange agent flow-path 110 comprises at least two branches 115, and each branch 115 is located at one side of each battery core 211. The width direction of the branches 115 is the same as the width direction of the battery cores 211; when the width of the battery cores 211 is defined is X and the width of the branches 115 is defined as Y, 0.5X≤Y<X.

From the above, by setting the width of the branches 115 to be greater than or equal to half the width of the battery cores 211, it is possible to obtain a sufficient contact area between the branches 115 and the battery cores 211, and at the same time ensure that there is enough heat exchange agent in the branches 115 so that the heat exchange with the battery cores 211 can be achieved quickly. Consequently, the heat exchange agent flow-path 110 can meet the power requirement of heat exchange of battery 200. In addition, by setting the width of the branches 115 to be smaller than the width of the battery cores 211, it is possible to avoid the width of the branches 115 being too large and thus exceeding the width of the battery cores 211, which would prevent some of the heat exchange agent in the branches 115 from participating in the heat exchange of the battery cores 211. Accordingly, it is possible to avoid adding excess weight and wasting the heat exchange power of the heat exchange agent flow-path 110, and achieve light weight.

In some embodiments, the width X of the battery cores 211 and the width Y of the branches 115 are defined as 0.5X≤Y≤0.6X.

As shown in FIG. 3, the heat exchange agent flow-path 110 in this embodiment of the present application includes a first flow section 113 and a second flow section 114, and the first flow section 113 and the second flow section 114 include at least two branches 115 arranged apart and in parallel, so that the positions of the branches 115 can correspond one-to-one with the arrangement of the battery cores 211, and thus the temperature regulation of the battery cores 211 can be performed more precisely. In addition, by providing at least two branches 115 in each of the first flow section 113 and the second flow section 114, the amount of heat exchange agent that can be accommodated in the first flow section 113 and the second flow section 114 can be reduced. Specifically, for example, as described in the following embodiment, the first flow section 113 and the second flow section 114 are divided into at least two branches 115 by providing a protrusion bar 131 in each of the first flow section 113 and the second flow section 114, thereby reducing the amount of heat exchange agent that can be accommodated in the first flow section 113 and the second flow section 114 because the protrusion bars 131 occupy space in the first flow section 113 and the second flow section 114. Meanwhile, since the width of the branches 115 does not have to be as long as the width of the battery cores 211 and there may be a gap between two adjacent battery cores 211, the following protrusion bars 131 are provided in the first flow section 113 and the second flow section 114 to reduce the inflow of the heat exchange agent and reduce the weight of the battery pack while satisfying the heat exchange effect.

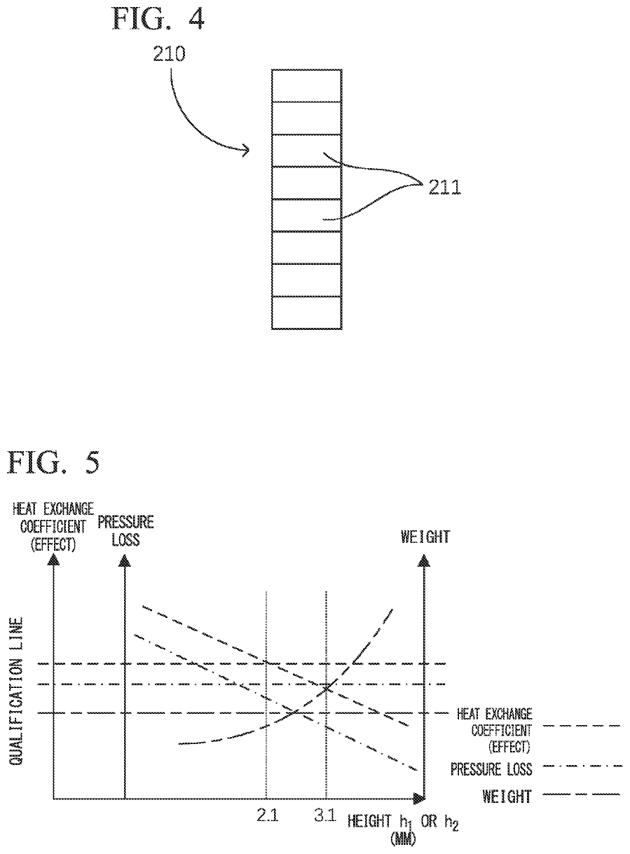

FIG. 4 is a schematic diagram of the structure of a battery module in FIG. 2. As shown in FIGS. 2 and 4, the battery cores 211 are arranged in parallel within the battery modules 210 of the battery 10. Specifically, as shown in FIGS. 2 and 4, the battery 200 may include at least two battery modules 210, and each battery module 210 includes at least two battery cores 211. The battery cores 211 are provided in parallel along their own width to form the battery modules 210, with the length direction of the battery cores 211 oriented in the same direction as the length direction of the housing 100.

The arrangement of the battery modules 210 is very limited due to the limited space available in the vehicle 1 for the battery pack 10. FIG. 2 illustrates a preferred arrangement of the battery modules 210, i.e., after the battery modules 210 are mounted, the length of the battery cores 211 is in the same direction as the front-back direction of the vehicle 1. Compared to other arrangements of the battery modules 210, for example, by having the battery modules 210 mounted with the length of the battery cores 211 in the same direction as the left-right direction of the vehicle 1, or having the battery modules 210 mounted with the length of the battery cores 211 of some of the battery modules 210 in the same direction as the front-back direction of the vehicle 1 and with the length of the battery cores 211 of some of the battery modules 210 in the same direction as the front-back direction of the vehicle 1, the maximum number of battery modules 210 can be mounted in accordance with the arrangement of the battery modules 210 in FIG. 2.

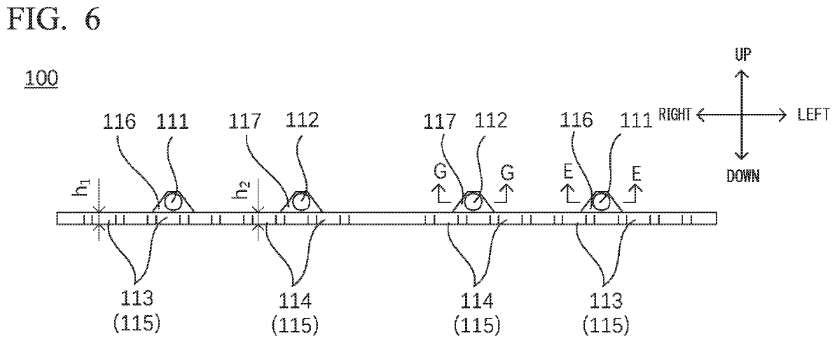

FIG. 5 is a schematic diagram of the heat exchange coefficient, pressure loss, and weight of the heat exchange agent in the heat exchange agent flow-path 110 in FIG. 3 as a function of the height of the heat exchange agent flow-path; FIG. 6 is a schematic diagram of the side structure of the housing 100 in FIG. 3, in which the heights of the first flow section 113 and the second flow section 114 are identified. As shown in FIGS. 5 and 6, in some embodiments, the height dimension of the first flow section 113 may be defined as h1 and the height dimension of the second flow section 114 may be defined as h2. In the case of a constant flow rate of the heat exchange agent in the heat exchange agent flow-path 110, the heat exchange coefficient (effect), pressure loss and weight of the heat exchange agent in the first flow section 113 and the second flow section 114 change accordingly with the increase of the height h1 of the first flow section 113 and the height h2 of the second flow section.

Specifically, as the height h1 of the first flow section 113 increases, the volume of the heat exchange agent in the first flow section 113 increases. Accordingly, the weight of the heat exchange agent accommodated in the first flow section 113 also increases. Similarly, as the height h2 of the second flow section 114 increases, the weight of the heat exchange agent accommodated in the second flow section 114 also increases.

As the height h1 of the first flow section 113 increases, it allows the size of the cross section perpendicular to the flow direction of the heat exchange agent in the first flow section 113 to increase. Since the flow volume of the heat exchange agent remains the same, it makes the flow rate of the heat exchange agent decrease. The faster the flow rate of the heat exchange agent, the faster the heat exchange between the heat exchange agent and the battery 200, i.e., the larger the heat exchange coefficient of the heat exchange agent is, the better the heat exchange effect is. Therefore, as the height h1 of the first flow section 113 increases, the heat exchange coefficient of the heat exchange agent in the first flow section 113 decreases. Similarly, as the height h2 of the second flow section 114 increases, the heat exchange coefficient of the heat exchange agent in the second flow section 114 also decreases gradually.

As the height h1 of the first flow section 113 increases, the size of the cross section perpendicular to the flow direction of the heat exchange agent in the first flow section 113 increases. Consequently, the heat exchange agent can flow more easily in the first flow section 113, so that the pressure loss of the heat exchange agent in the first flow section 113 decreases. Similarly, as the height h2 of the second flow section 114 increases, the pressure loss of the heat exchange agent in the second flow section 114 also reduces. FIG. 5 also shows the qualification lines for the heat exchange coefficient (effect), pressure loss and weight of the heat exchange agent. As shown in FIG. 5, according to the qualification lines of the heat exchange coefficient (effect), pressure loss and weight of the heat exchange agent, combined with the influence of the heights h1 and h2 on the heat exchange coefficient (effect), pressure loss and weight of the heat exchange agent, it is known that when the height h1 of the first flow section 113 and the height h2 of the second flow section 114 are less than 2.1 mm, although the heat exchange coefficient of heat exchange agent is large and the heat exchange effect is good, the pressure loss of heat exchange agent is larger and the requirement for the pump driving the flow of heat exchange agent is too high, which will make the selection of the pump more difficult and increase the production cost of the vehicle. When the height h1 of the first flow section 113 and the height h2 of the second flow section 114 are greater than 3.1 mm, although the pressure loss of the heat exchange agent can be reduced, it will also lead to too much weight of the heat exchange agent, which will increase the energy consumption of the vehicle and affect the driving range of the vehicle. Meanwhile, it will also make the heat exchange coefficient of the heat exchange agent too small and the heat exchange effect poor. Therefore, preferably, the height h1 of the first flow section 113 and the height h2 of the second flow section 114 can be set within 2.1 mm to 3.1 mm. Accordingly, the weight of the heat exchange agent in the heat exchange agent flow-path 110 can be reduced while the pressure loss of the heat exchange agent in the heat exchange agent flow-path 110 can be reduced, and a good heat exchange coefficient can be obtained.

As shown in FIG. 3, the width of each branch 115 in this embodiment of the application is the same. In this way, the pressure loss of the heat exchange agent between the different branches 115 is more uniform, and the pressure loss of the heat exchange agent in the heat exchange agent flow-path 110 is not increased due to the excessive pressure loss of one of the branches 115. Meanwhile, by setting the widths of the branches 115 to be the same, the flow rate of the heat exchange agent in each branch 115 can be made more uniform, and thus the regulating rate of the core temperature can be made more uniform, and the temperature regulating effect can be improved.

As shown in FIGS. 2 and 3, in some embodiments, the branches 115 extend in the length direction of the battery cores 211.

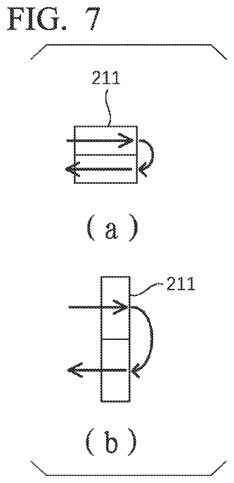

FIG. 7 is a comparison diagram of a heat exchange agent flow-path 110 extending in the length and width directions of the battery cores 211. (a) in FIG. 7 shows the heat exchange agent flow-path 110 extending in the length direction of the battery cores 211, and (b) in FIG. 7 shows the heat exchange agent flow-path 110 extending in the width direction of the battery cores 211. As shown in FIG. 7, since the length dimension of battery cores 211 is larger than the width dimension, according to the corresponding relationship between the width/length of the branches 115 and the battery cores 211, the first flow section 113, the second flow section 114 and their branches 115 can extend in the length direction of battery cores 211 as shown in (a) in FIG. 7, which can reduce the width of the first flow section 113, the second flow section 114 and their branches 115; and can also reduce the length required for the turning of the first flow section 113 and the second flow section 114, i.e., the length of the fluxion cavity 118. In turn, the flow volume of the heat exchange agent can be reduced and the weight of the core can be decreased. In addition, when the first flow section 113, the second flow section 114 and their branches 115 extend in the width direction of the battery cores 211 as shown in (b) in FIG. 7, compared to when the first flow section 113, the second flow section 114 and their branches 115 extend in the length direction of the battery cores 211 as shown in (a) in FIG. 7, the heat exchange agent flow-path 110 requires a larger bend arc and a larger bend distance when making a turn. If the bend arc of the heat exchange agent flow-path 110 in (b) of FIG. 7 is reduced, the pressure loss of the heat exchange agent flowing in the first flow section 113 and the second flow section 114 increases. Consequently, the extension of the heat exchange agent flow-path 110 in the length direction of the battery cores 211 can shorten the length of the heat exchange agent flow-path 110, thus reducing the pressure loss of the heat exchange agent and achieving light weight.

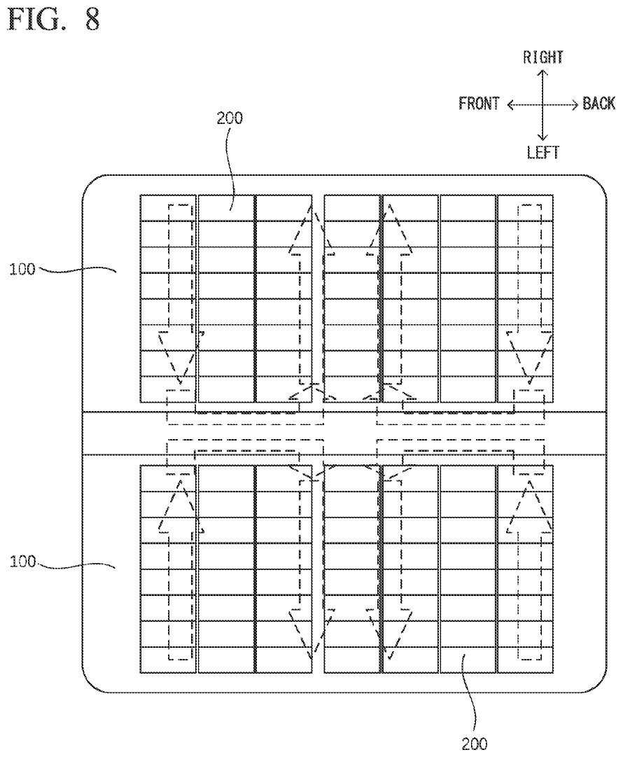

FIG. 8 is a schematic diagram of a comparative example of the flow direction of a heat exchange agent. The arrows in FIG. 8 show the flow direction of the heat exchange agent when the first flow section 113 and the second flow section 114 extend in the width direction of the battery cores 211. Comparing FIG. 8 with FIG. 3, it can be seen that when the first flow section 113 and the second flow section 114 are arranged in the length direction of the battery cores 211, the number of turns in the first flow section 113 and the second flow section 114 is smaller than the number of turns in the first flow section 113 and the second flow section 114 arranged in the width direction of the battery cores 211. Therefore, the length of the heat exchange agent flow-path 110 and the number of turns can be reduced, so that the pressure loss of the heat exchange agent can be reduced and the temperature regulation effect can be improved.

As shown in FIG. 3, the housing 100 in this embodiment of the application is provided with a first mounting position 120, which can be a mounting hole, a positioning hole, a positioning post or another structure, and the first mounting position 120 is set between two of the branches 115. Specifically, as shown in FIG. 3, according to the needs of the structure, the first mounting position 120 can be provided between only some of the branches. The branches 115 are provided with a deflecting bend 119 turning to the left or right to avoid the first mounting position 120.

Consequently, when the first mounting position 120 is between the branches 115, it is possible to avoid the first mounting position 120 by providing a deflecting bend 119 in the branches 115. Accordingly, the interference between the branches 115 and the first mounting position 120 can be improved.

As shown in FIG. 3, the farther away from the first mounting position 120 a branch 115 is, the smaller the curvature of the deflecting bend 119 in the branch 115 is.

Accordingly, the width of the branches 115 at the deflecting bend 119 is approximately the same as the width at the other portions, thereby making the flow rate of the heat exchange agent in the branches 115 uniform and the temperature regulation effect uniform. Moreover, the pressure loss of the heat exchange agent between the different branches 115 is more uniform, which improves the temperature regulation effect.

As shown in FIG. 3, the heat exchange agent flow-path in this embodiment of the application may also include a heat exchange agent inlet 111 and a heat exchange agent outlet 112, with one end of the first flow section 113 communicated with the heat exchange agent inlet 111 via an inflow cavity 116 and one end of the second flow section 114 communicated with the heat exchange agent outlet 112 via an outflow cavity 117. Consequently, the heat exchange agent provided by the heat exchange agent inlet 111 can be dispersed to each branch 115 through the inflow cavity 116, and the heat exchange agent in each branch 115 can be converged via the outflow cavity 117 and discharged from the heat exchange agent outlet 112. Accordingly, the pressure loss of the heat exchange agent can be reduced and the temperature regulation efficiency of the heat exchange agent can be improved.

FIG. 6 also shows the position and shape of the first flow section 113, the second flow section 114, the heat exchange agent inlet 111 and the heat exchange agent outlet 112 from the side of the housing 100. As shown in FIG. 6, the heat exchange inlet 111 is positioned further up than the first flow section 113; and/or the heat exchange agent outlet 112 is positioned further up than the second flow section 114. Accordingly, it is possible to avoid collision between the heat exchange agent inlet 111 and the heat exchange agent outlet 112 and the connected pipes thereof and other components with the objects appearing under the housing 100, and reduce the chance of leakage due to collision. Consequently, the protective structure for the heat exchange agent inlet 111 and the heat exchange agent outlet 112 can be eliminated, thus simplifying the structure of the housing 100 and reducing the weight of the housing 100.

As shown in FIG. 6, the cross-sectional area of the inflow cavity 116 in the horizontal direction of this embodiment of the application gradually increases from top to bottom. Accordingly, the heat exchange agent flowing in the inflow cavity 116 can be guided so that the heat exchange agent flows in the inflow cavity 116 towards the branches 115 in a diffuse manner. Accordingly, the pressure loss of the heat exchange agent in the inflow cavity 116 is reduced and the flowing of the heat exchange agent is facilitated, improving the temperature regulation effect.

As shown in FIG. 6, the cross-sectional area of the outflow cavity 117 in the horizontal direction of this embodiment of the application gradually decreases from bottom to top. Accordingly, the heat exchange agent flowing in the outflow cavity 117 can be guided so that the heat exchange agent gradually converges as it flows in the outflow cavity 117 toward the heat exchange agent outlet 112, so that the heat exchange agent is discharged from the heat exchange agent outlet 112. Consequently, the pressure loss of the heat exchange agent in the inflow cavity 116 can be reduced, thereby facilitating the flowing of the heat exchange agent and improving the temperature regulation effect.

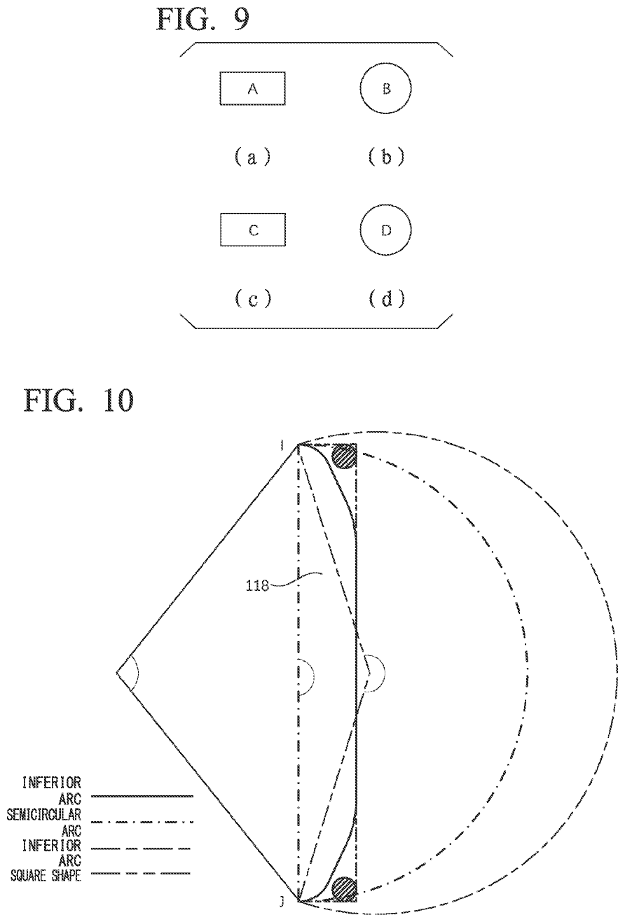

FIG. 9 is a schematic diagram for illustrating the shape of the heat exchange agent flow-path. (a) in FIG. 9 shows the cross section of the inflow cavity 116 in the E-E direction in FIG. 5, (b) in FIG. 9 shows the cross section of the heat exchange agent inlet 111 in the F-F direction in FIG. 3, (c) in FIG. 9 shows the cross section of the outflow cavity 117 in the G-G direction in FIG. 5, and (d) in FIG. 9 shows the cross section of the heat exchange agent outlet 112 in the H-H direction in FIG. 3.

(a) in FIG. 9 shows a horizontal cross section of the inflow cavity 116 at the position communicated with the heat exchange agent inlet 111, with the area defined as A. (b) in FIG. 9 shows a cross section of the heat exchange agent inlet 111, with the area defined as B. The position communicated with the heat exchange agent inlet 111 at the inflow cavity 116 may be specifically the center position of the vertical cross section of the heat exchange agent inlet 111.

(c) in FIG. 9 shows a horizontal cross section on the outflow cavity 117 at the position communicated with the heat exchange agent outlet 112, defining its area as C. (d) in FIG. 9 shows a cross section of the heat exchange agent outlet 112, defining its area as D. The relationship between C and D can be 0.5C≤D≤1.2C.

Specifically, as shown in FIGS. 3 and 9, the cross section of the heat exchange agent inlet 111 and the heat exchange agent outlet 112 is a vertical cross section perpendicular to the orientation of the heat exchange agent inlet 111 and the heat exchange agent outlet 112. Alternatively, when the heat exchange agent inlet 111 and the heat exchange agent outlet 112 are, for example, cylindrical in shape, the cross section of the heat exchange agent inlet 111 and the heat exchange agent outlet 112 is a cross section perpendicular to the axis direction of the heat exchange agent inlet 111 and the heat exchange agent outlet 112.

Since the heat exchange agent inlet 111 and the heat exchange agent outlet 112 are located at the top of the flow section, the flowing of the heat exchange agent in the inflow cavity 116 and the outflow cavity 117 is from top to bottom. Accordingly, the horizontal cross-sectional area of the inflow cavity 116 and the outflow cavity 117 is the cross-sectional area of the flowing of the heat exchange agent in the inflow cavity 116 and the outflow cavity 117. The vertical cross-sectional area of the heat exchange agent inlet 111 and the heat exchange agent outlet 112 is the cross-sectional area of the flowing of the heat exchange agent in the heat exchange agent inlet 111 and the heat exchange agent outlet 112.

If the relationship between A and B is B<0.5A, the size of the heat exchange agent inlet 111 will be too small and the flow rate of the heat exchange agent needs to be increased in order to be able to meet the flow volume demand when delivering the heat exchange agent from the heat exchange agent inlet 111 to the inflow cavity 116. Consequently, the performance requirements of the pump that drives the flow of the heat exchange agent will be increased, which will make the selection of the pump more difficult and increase the production cost of the vehicle.

If the relationship between C and D is D<0.5C, the size of the heat exchange agent outlet 112 will be too small, and the pressure loss of the heat exchange agent will be too large when the heat exchange agent flows from the outflow cavity 117 to the heat exchange agent outlet 112, which in turn will affect the heat exchange efficiency.

If the relationship between A and B is B>1.2A, the size of the inflow cavity 116 will be too small and the pressure loss of the heat exchange agent will be too large when the heat exchange agent flows from the heat exchange agent inlet 111 into the inflow cavity 116, thus affecting the heat exchange efficiency.

If the relationship between C and D is D>1.2C, the size of the heat exchange agent outlet 112 will be too large, and the size of the pipe connected to the heat exchange agent outlet 112 will be increased, thus increasing the amount of the heat exchange agent that can be accommodated in the heat exchange agent outlet 112 and the pipe connected to it, reducing the use efficiency of the heat exchange agent, increasing the weight and energy consumption of the vehicle, and affecting the driving range of the vehicle.

By setting the vertical cross-sectional area of the heat exchange agent inlet 111 to 0.5 times to 1.2 times the horizontal cross-sectional area of the inflow cavity 116 and setting the vertical cross-sectional area of the heat exchange agent outlet 112 to 0.5 times to 1.2 times the horizontal cross-sectional area of the outflow cavity 117, the space for the heat exchange agent to pass through does not change much when the heat exchange agent flows through the heat exchange agent inlet 111, the heat exchange agent outlet 112, the inflow cavity 116, and the outflow cavity 117. Hence, the pressure loss of the heat exchange agent is reduced and the sudden change of the flow rate of the heat exchange agent is avoided, thus improving the heat exchange efficiency.

In some embodiments, the horizontal cross-sectional area A of the inflow cavity 116 and the vertical cross-sectional area B of the heat exchange agent inlet 111 can be set to A=B; and/or the horizontal cross-sectional area C of the outflow cavity 117 and the vertical cross-sectional area D of the heat exchange agent outlet 112 can be set to C=D. Accordingly, when the heat exchange agent flows through the heat exchange agent inlet 111, the heat exchange agent outlet 112, the inflow cavity 116, and the outflow cavity 117, the space for the heat exchange agent to pass through remains constant, thus further reducing the pressure loss of the heat exchange agent and improving the heat exchange efficiency.

As shown in FIG. 3, the first flow section 113 and the second flow section 114 in this embodiment of the application form a U-shaped structure. Accordingly, compared with an S-shaped heat exchange agent flow-path 110, the number of turns of the heat exchange agent can be reduced, and thus the pressure loss of the heat exchange agent can be reduced and the temperature regulation effect can be improved.

As shown in FIG. 3, the heat exchange agent flow-path 110 in this embodiment of the application also includes a fluxion cavity 118 communicating with the other end of the first flow section 113 and the other end of the second flow section 114. The first flow section 113 and the second flow section 114 are connected to the fluxion cavity 118 to together form a U-shaped structure. Accordingly, the heat exchange agent in a plurality of branches 115 of the first flow section 113 can converge in the flow cavity 118 and be delivered by the flow cavity 118 to a plurality of branches 115 of the second flow section 114. Consequently, it is possible to reduce the pressure loss caused by splitting the heat exchange agent into at least two branches 115 when the heat exchange agent enters the second flow section 114 from the first flow section 113, and thus the temperature regulation effect can be improved.

The fluxion cavity 118 in this embodiment of the application has an arced cross section shape in the horizontal direction on one side away from the first flow section 113 and the second flow section 114. Specifically, the fluxion cavity 118 is arc-shaped when viewed from above. Accordingly, by providing the fluxion cavity 118 with an arced shape, the heat exchange agent in the fluxion cavity 118 can be guided, thereby reducing the pressure loss of the heat exchange agent in the fluxion cavity 118.

FIG. 10 is a schematic diagram of the fluxion cavity 118 in an embodiment of the present application compared with other shapes of the fluxion cavity. As shown in FIGS. 3 and 10, the fluxion cavity 118 in this embodiment of the application can be specifically provided with an inferior arc shape (i.e., the arc shape with the endpoints of I and J as shown in FIG. 10 corresponds to the angle at the center of the circle smaller than 180°). Compared with the fluxion cavity 118 with a semi-circular shape and the fluxion cavity 118 with a superior arc shape (i.e., the arc shape with the end points of I and J as shown in FIG. 10 corresponds to the angle at the center of the circle greater than 180°), the fluxion cavity 118 with inferior arc shape occupies less space. As shown in FIG. 10, when the fluxion cavity 118 is square, the heat exchange agent will accumulate in the shaded position in FIG. 10, and the heat exchange agent in the shaded position will not participate in the temperature regulation of the battery 200. This leads to waste of the heat exchange agent and reduces the temperature regulation efficiency of the heat exchange agent.

Accordingly, the fluxion cavity 118 is provided in an inferior arc, which reduces the volume of the flow cavity 118 and thus enables a more compact structure of the housing 100. It can also prevent some of the heat exchange agent from stagnating in the fluxion cavity 118 and not being able to participate in the temperature regulation of the battery 200, thus improving the temperature regulation efficiency of the heat exchange agent.

As shown in FIGS. 3 and 10, the fluxion cavity 118 has a trapezoidal cross-sectional shape in the horizontal direction, and the bottom edge of the trapezoid (i.e., the edge of the fluxion cavity 118 on one side communicated with the first flow section 113 and the second flow section 114) is set close to the side of the first flow section 113 and the second flow section 114, and the top edge of the trapezoid (the edge of the fluxion cavity 118 away from the side communicated with the first flow section 113 and the second flow section 114) is set away from the first flow section 113 and the second flow section 114. Since the length of the top edge of the trapezoid is smaller than the length of the bottom edge, by setting the cross-sectional shape of the fluxion cavity 118 in the horizontal direction to a trapezoid, it is possible to make the coolant in the first flow section 113 enter the fluxion cavity 118 from the bottom edge of the trapezoid near one side, and then the coolant can flow into the second flow section 114 from the bottom edge of the trapezoid near the other side under the guidance of both sides of the trapezoid and the top edge. As a result, the pressure loss of coolant in the fluxion cavity 118 can be reduced and some of the heat exchange agent can be prevented from stagnating in the fluxion cavity 118. Meanwhile, the trapezoidal structure can achieve the same effect of reducing the volume of the fluxion cavity 118 and making the structure of the housing 100 more compact compared with the cavity of the semi-circular structure or major arc structure.

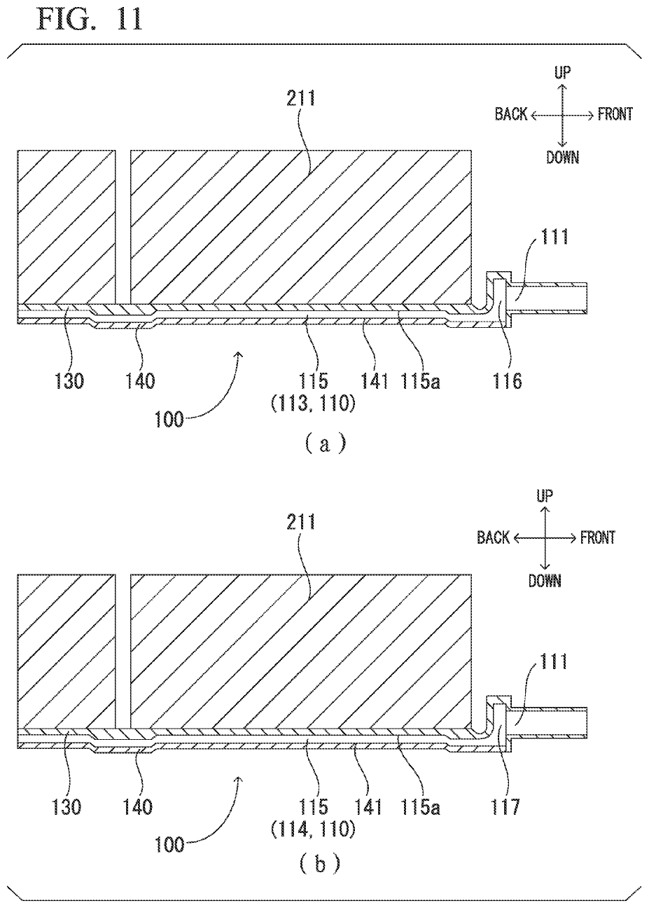

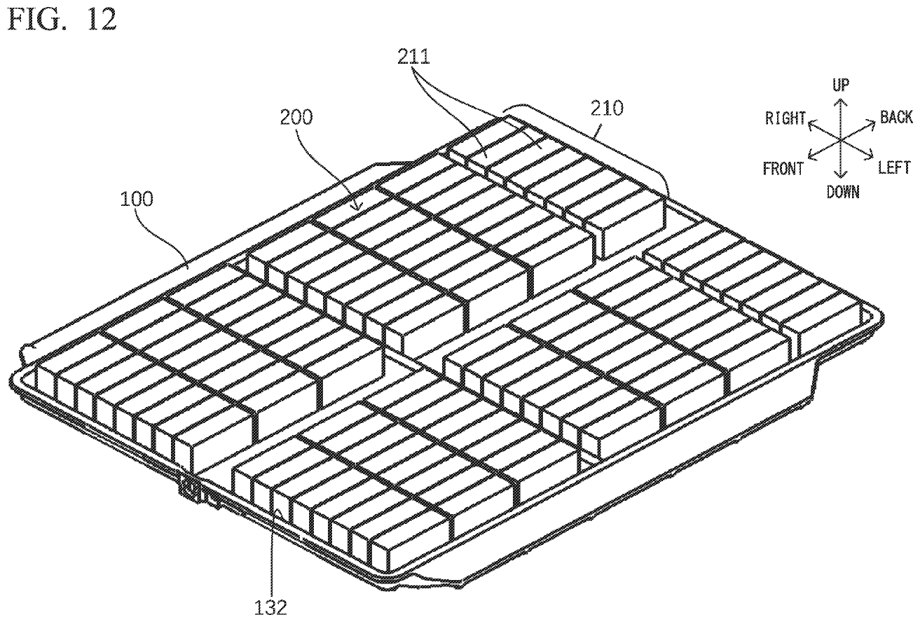

FIG. 11 is a schematic partial cross-sectional diagram of the housing 100 in the vertical plane at the position of the heat exchange agent inlet 111 and the heat exchange agent outlet 112 in this embodiment of the application. (a) in FIG. 11 shows a partial cross section of the housing 100 at the position of the heat exchange agent inlet 111, and (b) in FIG. 11 shows a partial cross section of the housing 100 at the position of the heat exchange agent outlet 112. As shown in FIG. 11, the housing 100 can also include a lower housing 130 and a base plate 140 mounted in the lower housing 130, with a heat exchange agent flow-path 110 formed between the base plate 140 and the lower housing 130, thus eliminating the need for individual components such as heat exchange tubes for the flow of the heat exchange agent. Accordingly, the structure of the housing 100 can be simplified, and the weight of the housing 100 can be reduced to achieve light weight. Meanwhile, it is possible to reduce the number of parts of the housing 100, reduce the assembly steps and assembly time, and improve the assembly efficiency.

As shown in FIG. 11, the base plate 140 is provided with at least two bumps 141 protruding toward the lower housing 130; and the bumps 141 correspond one-to-one to the positions of the battery cores 211. Specifically, the bumps 141 may be made by means of sheet metal, whereby the bumps 141 are convex on the upper surface of the base plate 140 and concave on the lower surface of the base plate 140. The bumps 141 may be rectangular in shape corresponding to the shapes of the battery cores 211, with the surface areas of the upper surfaces of the bumps 141 being approximately equal to the surface areas of the lower surfaces of the battery cores 121. Accordingly, compared with the base plate of the same thickness in the form of a flat plate, the structural strength of the base plate 140 with the bumps 141 is greater, and the strength of the base plate 140 at the positions corresponding to the battery cores 211 can be enhanced. In addition, in order to meet the strength requirement of the base plate 140, a method of providing the bumps 141 on the base plate 140 is adopted. Compared with the method of increasing the thickness of the base plate 140, the method of providing the bumps 141 on the base plate 140 can reduce the thickness and weight of the base plate 140, and thus can reduce the weight of the housing 100 and achieve light weight.

In addition, when the upper surface of the base plate 140 needs to be machined with a milling cutter, only the upper surfaces of the bumps 141 need to be machined, i.e., only the positions corresponding to the battery cores 211 need to be machined, thus reducing the workload of the milling cutter and increasing the machining speed.

As shown in FIG. 11, concave parts 115a are also provided on the side of the lower housing 130 near the bottom plate 140 in the direction of recessing away from the bottom plate 140. The concave parts 115a are rectangular in shape and are located at corresponding positions over the bumps 141, forming concave shapes upward. Accordingly, the thickness of the housing 130 at the corresponding position of the battery cores can be made smaller than the thickness of the housing 130 at other positions, thereby enhancing the heat exchange efficiency between the battery cores and the heat exchange agent in the branches 115. In addition, by providing the concave parts 115a, it is also possible to keep the height of the branches 115 constant while the branches 115 undulate up and down, so as to prevent the height of the branches 115 from being influenced by the bumps 141 and causing the pressure loss to increase. Meanwhile, as shown in FIG. 11, the up and down undulation of the branches 115 is small, so that the influence of the up and down undulation of the branches 115 on the pressure loss of the heat exchange agent in the branches 115 can be reduced, thus ensuring the heat exchange efficiency of the heat exchange agent.

In some embodiments, the lower housing 130 and the battery 200 may also be connected to each other by a heat transfer adhesive. Accordingly, the heat exchange effect between the lower housing 130 and the battery 200 can be improved, thereby improving the temperature regulation effect.

In some embodiments, the housing 100 may also include a heat insulation layer (not shown), which is provided on the side of the base plate 140 away from the lower housing 130. Consequently, the influence of the ambient temperature on the housing 100 and the battery 200 inside the housing 100 can be reduced.

As shown in FIGS. 1 to 11, the battery pack 10 described above may be provided in the bodywork 20 of the vehicle 1, with the first flow section 113, the second flow section 114 and the branches 115 thereof in the battery pack 10 extending in the length direction of the vehicle 1.

From the above, it is possible to make the first flow section 113 and the second flow section 114 extend in the same direction as the length direction of the battery cores 211 when, for example, the length direction of the battery cores 211 in the battery pack 10 is the same as the length direction of the vehicle 1. Since the length of the battery cores 211 is larger than the width, under the condition that the first flow section 113 and the second flow section 114 have the same contact area with the battery cores 211, when the first flow section 113 and the second flow section 114 extend in the length direction of the vehicle 1, compared with when the first flow section 113 and the second flow section 114 extend in the width direction of the vehicle 1, when the first flow section 113 and the second flow section 114 extend in the length direction of the vehicle 1, the length and width of the first flow section 113 and the second flow section 114 are smaller at the turning position. As a result, the capacity of the heat exchange agent in the turning position of the first flow section 113 and the second flow section 114 can be reduced, and thus the weight of the battery pack 10 and the vehicle 1 can be reduced and light weight can be achieved.

The foregoing, in conjunction with FIGS. 2 to 11, describes possible embodiments of a battery pack for the vehicle of the present application. In the following, the specific structure of one embodiment of the battery pack 10 of the vehicle 1 of the present application will be described in detail in conjunction with the accompanying drawings.

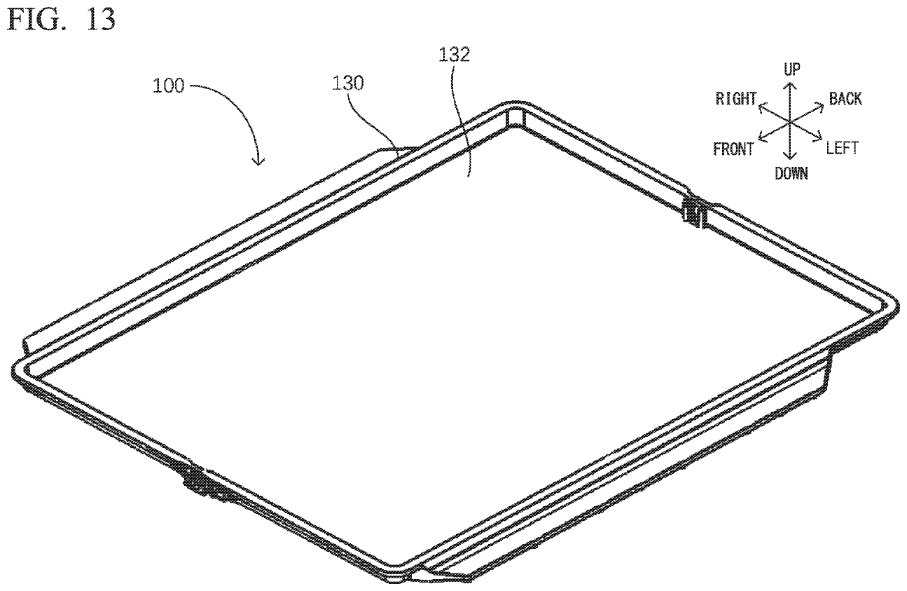

FIG. 12 is a schematic diagram of the three-dimensional structure of the battery pack 10 in an embodiment of the present application. As shown in FIG. 12, the battery pack in this embodiment includes a housing 100 and a battery 200, with a mounting part 132 provided on the upper surface of the housing 100, and the battery 200 is mounted and secured on the mounting part 132. The battery 200 includes 14 battery modules 210, and each battery module 210 includes 8 battery cores 211. As shown in FIG. 12, according to the size of the mounting space provided by the mounting part 132, the battery modules 210 are arranged in a 7×2 manner, i.e., 7 rows in the front-back direction of the housing 100 and 2 columns in the left-right direction of the housing 100. The battery cores 211 are rectangular in shape, the length direction of the battery cores 211 is the same as the front-back direction of the housing 100, and 8 battery cores 211 are arranged in parallel in the left-right direction of the housing 100.

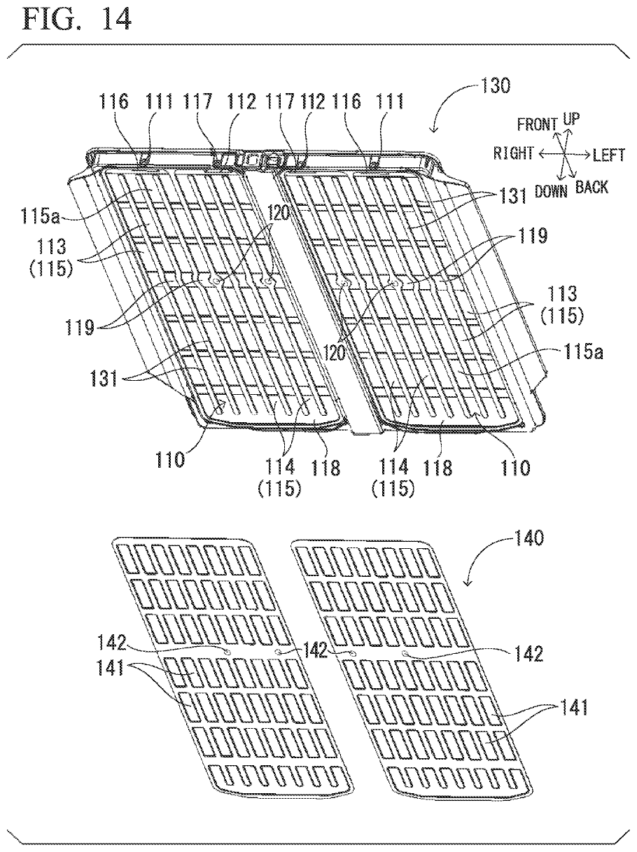

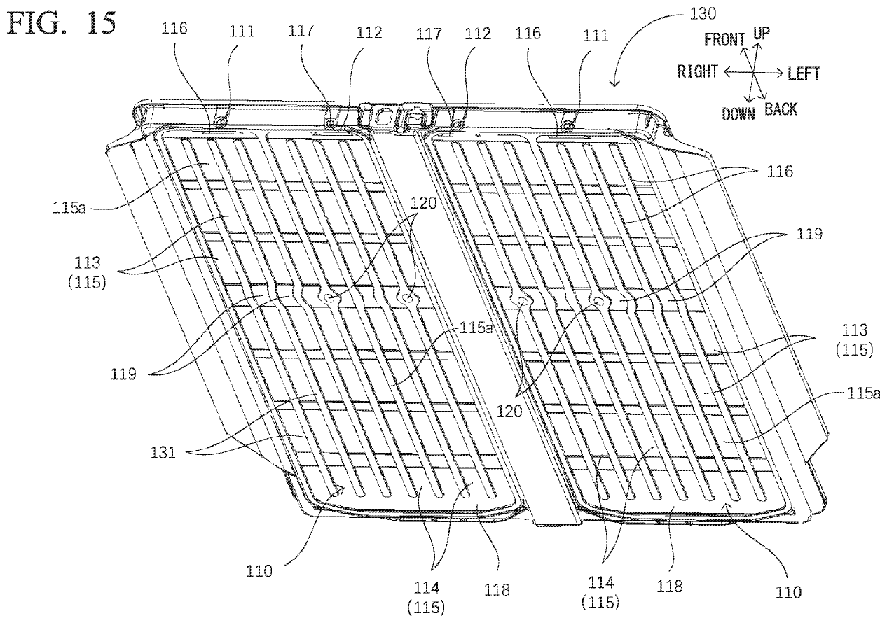

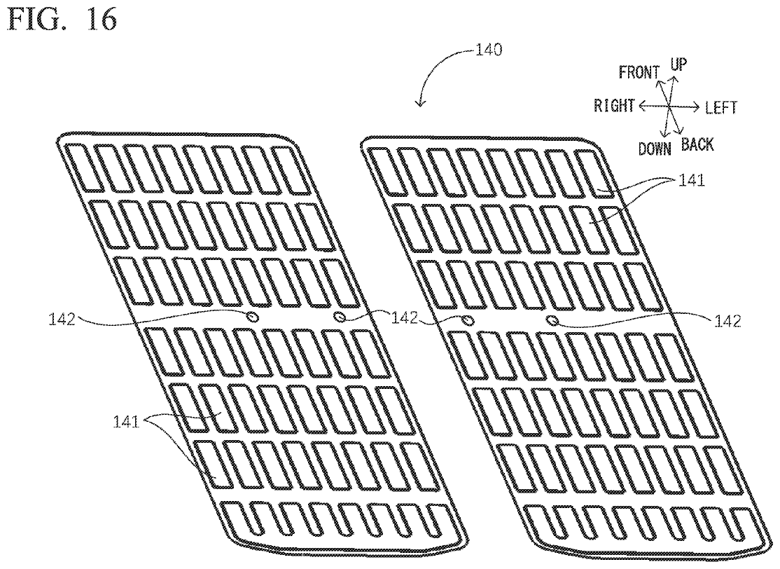

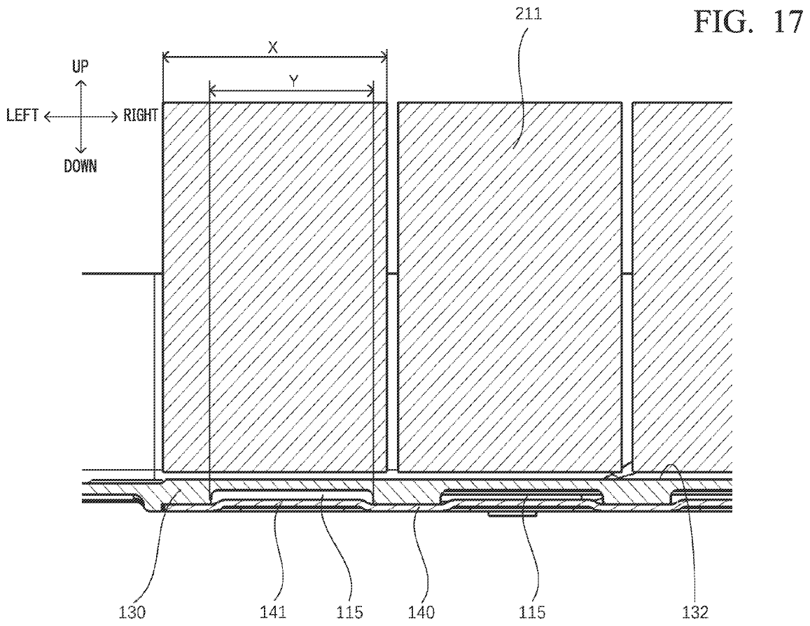

FIG. 13 is a schematic diagram of the structure of the housing 100 in FIG. 12; FIG. 14 is a disassembled schematic diagram of the housing 100 in FIG. 12; FIG. 15 is a schematic diagram of the structure of the lower housing 130 in FIG. 14; and FIG. 16 is a schematic diagram of the structure of the base plate 140 in FIG. 14. As shown in FIGS. 12 and 13, the housing 100 is a rectangular shaped shell-like component. The housing 100 may be mounted, for example, on the underside of the vehicle 1 or may be mounted at other suitable locations in the vehicle 1 without limitation.

As shown in FIGS. 12 to 16, the housing 100 in this embodiment of the application includes a lower housing 130 and a base plate 140, wherein the mounting part 132 is in the form of a tray and is provided on the upper surface of the lower housing 130. The battery 200 may be provided on the mounting part 132 as shown in FIG. 12, and then the housing 100 is mounted in the vehicle 1, thereby enclosing the battery 200 in the vehicle 1 to provide effective protection for the battery 200. Alternatively, the housing 100 may also include an upper housing (not shown) that may be securely mounted on the upper portion of the lower housing 130, enclosing the battery 200 between the upper housing and the lower housing 130, thereby providing effective protection for the battery 200. A heat transfer adhesive may also be applied between the battery 200 and the lower housing 130, thereby improving the heat conductivity between the battery 200 and the lower housing 130.

As shown in FIGS. 14 and 16, the base plate 140 is mounted on the lower surface of the lower housing 130, and heat exchange agent flow-paths 110 are formed between the base plate 140 and the lower housing 130. Two heat exchange agent flow-paths 110 are provided, and arranged in parallel in the width direction of the lower housing 130. The heat exchange agent flow-paths 110 include a first flow section 113 and a second flow section 114, with the first flow section 113 and the second flow section 114 extending in the length direction of the lower housing 130 in parallel, and the first flow section 113 being farther from the center of the battery 200 than the second flow section 114. The first flow section 113, the second flow section 114 and the fluxion cavity 118 are in a U-shaped structure. The lower housing 130 is also provided with a heat exchange agent inlet 111 and a heat exchange agent outlet 112, with the heat exchange agent inlet 111 being farther from the center of the core 200 than the heat exchange agent outlet 112. One end of the first flow section 113 is communicated with the heat exchange agent inlet 111, one end of the second flow section 114 is communicated with the heat exchange agent outlet 112, and the other end of the first flow section 113 is communicated with the other end of the second flow section 114.

Accordingly, the heat exchange agent can enter the first flow section 113 from the heat exchange agent inlet 111, then flow through the second flow section 114, and finally discharge from the heat exchange agent outlet 112. Since the heat exchange agent inlet 111 is farther from the center of the battery 200 than the heat exchange agent outlet 112, the first flow section 113 is farther from the center of the battery 200 than the second flow section 114. Consequently, the heat exchange agent is able to first exchange heat with the outer part of the battery 200, which is strongly influenced by the ambient temperature, and then with the middle part of the battery 200, which is weakly influenced by the ambient temperature. Accordingly, the temperature difference between the different locations of the battery 200 can be reduced and the temperature regulation effect can be improved.

As shown in FIGS. 14 and 15, the lower surface of the lower housing 130 is provided with a plurality of protrusion bars 131 in parallel, and the plurality of protrusion bars 131 divide each of the first flow section 113 and the second flow section 114 into 4 branches 115 arranged in parallel. Specifically, the protrusion bars 131 are provided in the length direction of the battery cores 211, and after the base plate 140 is mounted on the lower housing 130, the protrusion bars 131 are abutted against the base plate 140, dividing each of the first flow section 113 and the second flow section 114 into 4 branches 115 arranged in parallel, and the branches 115 extend in the length direction of the battery cores 211, with each battery core 211 having a branch 115 underneath. There is no communication between the branches 115 in the middle thereof, and there is communication at the ends of the first flow section 113 and the second flow section 114 between the branches 115 in the first flow section 113 and between the branches 115 of the second flow section 114. Accordingly, each branch 115 can be set in correspondence with the battery core 211 of the battery 200, so that the temperature regulation of the battery core 211 can be precisely performed. Meanwhile, it is also possible to reduce the amount of heat exchange agent in the locations between adjacent battery cores that do not have a need for temperature regulation, thereby reducing the amount of heat exchange agent that is passed into the heat exchange agent flow paths 110.

As shown in FIGS. 14 and 15, the other end of the first flow section 113 and the other end of the second flow section 114 are communicated with the fluxion cavity 118, which is provided in an arc shape. Accordingly, the heat exchange agent in the fluxion cavity 118 can be guided, thereby reducing the pressure loss of the heat exchange agent in the fluxion cavity 118. It is also possible to prevent the heat exchange agent from stagnating in the fluxion cavity 118, thus improving the use efficiency of the heat exchange agent.

Further, as shown in FIGS. 14 and 15, the fluxion cavity 118 is specifically provided with an inferior arc shape to reduce the space occupied by the fluxion cavity 118 and make the structure of the housing 100 more compact.

As shown in FIGS. 14 and 15, the width of each branch 115 is the same, so that the pressure loss of heat exchange agent in different branches 115 can be more uniform, so as to avoid the pressure loss of the heat exchange agent in the heat exchange agent flow-paths 110 increased due to excessive pressure loss in one branch 115. Meanwhile, by setting the widths between the branches 115 to be the same, it also enables the flow rate of the heat exchange agent in each branch 115 to be more uniform, and thus the temperature regulation rate of the battery 200 to be more uniform, which improves the temperature regulation effect.

Moreover, when arranging the battery cores 211, two adjacent battery cores 211 are usually placed right against each other in order to reduce the dimension and utilize the mounting space more effectively. In addition, since the fluxion cavities 131 also need to occupy a certain amount of space, the width of the branches 115 can be set smaller than the width of the battery cores 211 as shown in FIG. 14 and FIG. 15.

Furthermore, the smaller the width of the branches 115 is, the smaller the area where the battery cores 211 and the branches 115 overlap in the vertical direction is, and accordingly, the lower the heat conductivity between the battery cores 211 and the branches 115 is. Therefore, in order to ensure the heat exchange efficiency between the battery cores 211 and the branches 115, the width of the branches 115 can be set to be greater than half of the width of the battery cores 211 as shown in FIG. 14 and FIG. 15.

As shown in FIGS. 14, 15, and 16, the lower housing 130 in this embodiment of the application is provided with a first mounting position 120, the base plate 140 is provided with a second mounting position 142 at a position corresponding to the first mounting position 120, and the first mounting position 120 and the second mounting position 142 are mounting holes. After the base plate 140 is mounted on the lower surface of the lower housing 130, the base plate 140 and the lower housing 130 can be mounted on the bodywork 20 by bolting through the first mounting position 120 and the second mounting position 142.

As shown in FIGS. 14 and 15, the first mounting position 120 is positioned in the middle of the two branches 115 (i.e., on the protrusion bars 131), and a mounting hole arranged to pass through the lower housing 130, the protrusion bars 131 form an arc-shaped turn at the positions corresponding to the left and right sides of the first mounting position 120, so that the branches 115 form deflecting bends 119 at the positions corresponding to the left and right sides of the first mounting position 120. The size of the arc-shaped turn in the protrusion bars 131 is set such that the farther a branch 115 is from the first mounting position 120, the smaller the curvature of the deflecting bend 119 in the branch 115 is. Consequently, the width of the branches 115 at the position of the deflecting bend 119 can be made more uniform, which in turn makes the flow rate of the heat exchange agent more uniform between the different branches 115 to improve the temperature regulation effect. Meanwhile, it is also possible to make the width of the branches 115 at the deflecting bend 119 not change too much, thus reducing the pressure loss of the heat exchange agent in the branches 115.

FIG. 17 is a partial cross-sectional enlarged view of the battery pack 211 in FIG. 12 at the corresponding positions of the battery cores 10. As shown in FIGS. 14, 16, and 17, the base plate 140 in this embodiment of the application is provided with bumps 141 protruding upward, and the bumps 141 are provided on the side of the base plate 140 toward the lower housing 130 and are located in positions corresponding to the battery cores 211. The width of the bumps 141 is smaller than the width of the branches 115, and the bumps 141 are located on the branches 115 after the base plate 140 is mounted on the lower housing 130. The bumps 141 on the base plate 140 may be made by means of sheet metal to form inner concave shapes on the lower surface of the base plate 140 at the positions corresponding to the bumps 141. Accordingly, the structural strength of the base plate 140 can be improved at the positions corresponding to the battery cores 211. Meanwhile, under the premise of meeting the strength requirements of the base plate 140, the thickness and weight of the base plate 140 can be reduced, and in turn, the weight of the housing 100 can be reduced to achieve light weight.

In addition, when the upper surface of the base plate 140 needs to be machined using a milling cutter, only the upper surfaces of the bumps 141 need to be machined, i.e., only the positions corresponding to the battery cores 211 need to be machined, thereby reducing the workload of milling cutter machining and increasing the machining speed.

As shown in FIGS. 14 and 15, the branches 115 are also provided with concave parts 115a, which are rectangular in shape and are located at positions corresponding to the tops of the bumps 141, forming concave shapes upward. Accordingly, the thickness of the housing 130 at the corresponding positions of the battery cores is smaller than the thickness of the other positions of the housing 130, thereby improving the heat exchange efficiency between the battery cores and the heat exchange agent in the branches 115. In addition, by providing the concave parts 115a, it is also possible to keep the height of the branches 115 constant and avoid the height of the branches from being affected by the bumps 141. Consequently, the pressure loss of the branches 115 can be reduced and the heat exchange efficiency of the heat exchange agent can be improved.

As shown in FIG. 17, the width direction of the branches 115 in this embodiment of the application is the same as the width direction of the battery cores 211. In the width direction of the battery cores 211, the branches 115 can be set in the middle of the battery cores 211, or can be set at positions off to the side as shown in FIG. 17. If the width of the battery cores 211 is defined as X and the width of the branches 115 is defined as Y, then 0.5≤Y<X.

Accordingly, by setting the width of the branches 115 to be greater than or equal to half of the width of the battery cores 211, sufficient contact area can be obtained between the branches 115 and the battery cores 211, and sufficient heat exchange agent can be present in the branches 115 so that heat exchange with the battery cores 211 can be achieved quickly. Accordingly, the heat exchange agent flow-path 110 can meet the heat exchange power requirements of the battery 200.

Alternatively, the width X of the battery cores 211 and the width Y of the branches 115 can be set to 0.5X≤Y≤0.6X. Accordingly, the weight of the battery 200 can be further reduced while sufficient heat exchange power is obtained.

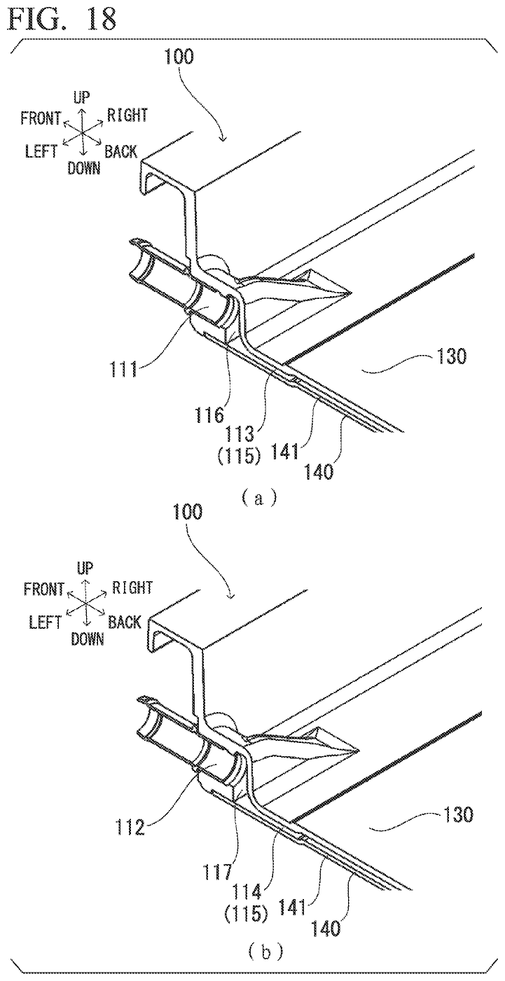

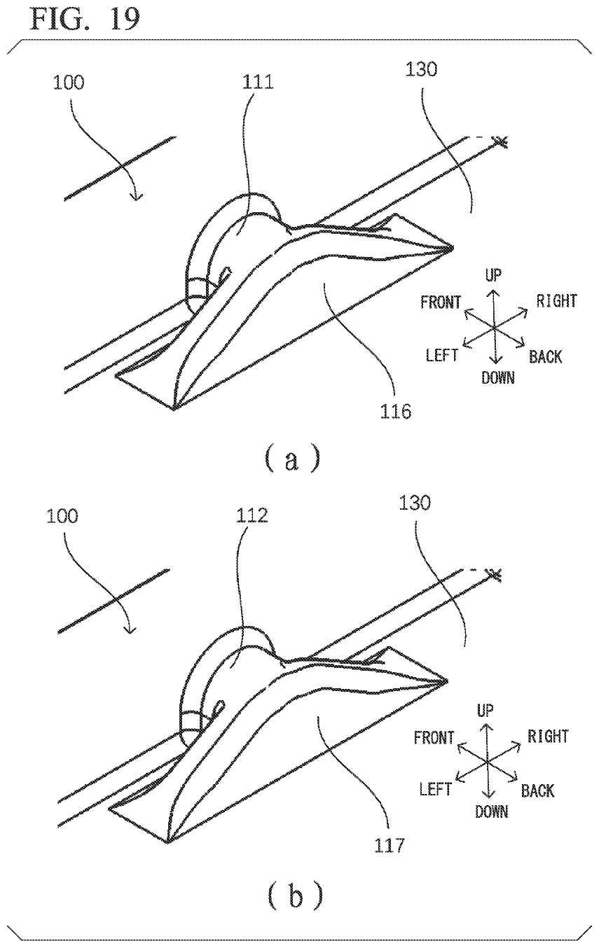

FIG. 18 is a radial sectional view of the heat exchange agent inlet 111 and the heat exchange agent outlet 112 in FIG. 13; FIG. 19 is a schematic partial enlarged view of the inlet cavity 116 and outlet cavity 117 in FIG. 13. As shown in FIGS. 15, 18, and 19, in this embodiment of the application, the inflow cavity 116 is communicated between the heat exchange agent inlet 111 and the first flow section 113, the outlet cavity 117 is communicated between the heat exchange agent outlet 112 and the second flow section 114, and the heat exchange agent inlet 111 and the heat exchange agent outlet 112 are located over the first flow section 113 and the second flow section 114. Specifically, the lower end of the inflow cavity 116 is communicated with one end of the first flow section 113, and the lower end of the outflow cavity 117 is communicated with one end of the second flow section 114. The heat exchange agent inlet 111 is set horizontally and communicated with the inflow cavity 116 at an upper position of the inflow cavity 116, and the heat exchange agent outlet 112 is set horizontally and communicated with the outflow cavity 117 at an upper position of the outflow cavity 117.

Accordingly, after the battery pack 10 is mounted on the bottom of the vehicle 1, by making the heat exchange agent inlet 111 and the heat exchange agent outlet 112 higher than the first flow section 113 and the second flow section 114, it is possible for the lower housing 130 to protect the heat exchange agent inlet 111 and the heat exchange agent outlet 112, so as to avoid collision of components such as the heat exchange agent inlet 111 and the heat exchange agent outlet 112 and their connected pipes with an object appearing under the vehicle 1 during the driving of the vehicle 1, reducing the chance of leakage due to collision. As a result, the protective structure for the heat exchange agent inlet 111 and the heat exchange agent outlet 112 can be reduced and the structural strength of the housing 100 can be enhanced.

As shown in FIGS. 18 and 19, the inflow cavity 116 has an overall trapezoidal shape, and the cross-sectional area of the inflow cavity 116 in the horizontal direction gradually increases from top to bottom. Accordingly, the flowing of the heat exchange agent in the inflow cavity 116 can be guided so that the heat exchange agent flows in the inlet cavity 116 to each branch 115 in a diffuse manner. Accordingly, the pressure loss of the heat exchange agent in the inflow cavity 116 can be reduced, and the flowing of the heat exchange agent can be facilitated to enhance the effect of temperature regulation.

As shown in FIGS. 18 and 19, the outflow cavity 117 has an overall trapezoidal shape, and the cross-sectional area of the outflow cavity 117 in the horizontal direction gradually decreases from bottom to top. Accordingly, the heat exchange agent flowing in the outflow cavity 117 can be guided, so as to enable the heat exchange agent to gradually converge when flowing in the outflow cavity 117 toward the heat exchange agent outlet 112, so that the heat exchange agent is discharged from the heat exchange agent outlet 112. Consequently, the pressure loss of the heat exchange agent in the inflow cavity 116 can be reduced to facilitate the flow of the heat exchange agent and improve the temperature regulation effect.

Furthermore, the area of the horizontal cross section of the inflow cavity 116 at the position thereof communicated with the heat exchange agent inlet 111 is equal to the area of the vertical cross section of the heat exchange agent inlet 111, and the area of the horizontal cross section of the outflow cavity 117 at the position communicated with the heat exchange agent outlet 112 is equal to the area of the vertical cross section of the heat exchange agent outlet 112. Accordingly, when the heat exchange agent flows through the heat exchange agent inlet 111, the heat exchange agent outlet 112, the inflow cavity 116, and the outflow cavity 117, the size of the space for the heat exchange agent to pass through is kept constant, thus further reducing the pressure loss of the heat exchange agent and improving the heat exchange efficiency.

The vehicle 1 is provided with the above-mentioned battery pack 10, and the width of the branches 115 is set to be more than or equal to half of the width of the battery cores 211, so as to obtain a sufficient contact area between the branches 115 and the battery cores 211, as well as to ensure that there is enough heat exchange agent in the branches 115, thereby enabling rapid heat exchange with the battery cores 211. Accordingly, the heat exchange agent flow-path 110 can meet the demand of the heat exchange power of the battery 200. In addition, by setting the width of the branches 115 to be smaller than the width of the battery cores 211, it is possible to prevent the width of the branches 115 from being too large and exceeding the width of the battery cores 211, resulting in some of the heat exchange agent in the branches 115 not being able to participate in the heat exchange of the battery cores 211. Accordingly, it is possible to avoid adding extra weight and wasting the heat exchange power of the heat exchange agent flow-path 110, and achieve the light weight of the vehicle 1.

After the battery pack 10 is mounted in the bodywork 20 of the vehicle 1, the first flow section 113, the second flow section 114 and the branch 115 inside the battery pack extend in the length direction of the vehicle 1.

From the above, for example, when the length direction of the battery cores 211 in the battery pack 10 is the same as the length direction of the vehicle 1, it is possible to enable the first flow section 113 and the second flow section 114 to extend in the same direction as the length direction of the battery cores 211. Since the length dimension of the battery cores 211 is larger than the width dimension thereof, under the condition that the first flow section 113 and the second flow section 114 have the same contact area with the battery cores 211, the first flow section 113 and the second flow section 114 extend in the length direction of the vehicle 1, in comparison with the first flow section 113 and the second flow section 114 extending in the width direction of the vehicle 1, when the first flow section 113 and the second flow section 114 extend in the length direction of the vehicle 1, the length and width of the first flow section 113 and the second flow section 114 at the turning position are smaller. Accordingly, the capacity of the heat exchange agent at the turning positions of the first flow section 113 and the second flow section 114 can be reduced, so as to reduce the weight of the battery pack 10 and the vehicle 1 and achieve light weight.

In conjunction with the accompanying drawings and description above, it is known that, in one embodiment of the battery pack 10 of the vehicle 1 of the present application, battery pack 10 includes a housing 100, and a battery 200 provided in the housing 100.

The battery 200 includes at least two battery cores 211 arranged in parallel, and the length direction of the battery cores 211 is the same as the length direction of the vehicle 1.

The housing 100 is provided with heat exchange agent flow-paths 110 for regulating the temperature of the battery 200, and two heat exchange agent flow-paths 110 are provided and are centered symmetrically on the center line L. The heat exchange agent flow-paths 110 include a heat exchange agent inlet 111 and a heat exchange agent outlet 112, with the heat exchange agent inlet 111 being farther from the center line L than the heat exchange agent outlet 112. The heat exchange agent flow-paths 110 also include a first flow section 113 and a second flow section 114, with the first flow section 113 and the second flow section 114 being provided in a straight line. One end of the first flow section 113 is communicated with the heat exchange agent inlet 111, and one end of the second flow section 114 is communicated with the heat exchange agent outlet 112. The other end of the first flow section 113 is communicated with the other end of the second flow section 114 via the fluxion cavity 118, and together they form a U-shaped structure. The first flow section 113 is farther away from the centerline than the second flow section 114.

From the above, it is possible to make the heat exchange agent enter the first flow section 113 from the heat exchange agent inlet 111, and then exchange heat with the outer part of the battery 200 which is strongly influenced by the ambient temperature; and then after the heat exchange agent flows into the second flow section 114, it exchanges heat with the middle part of the battery 200 which is weakly influenced by the ambient temperature. Accordingly, the temperature difference between the different positions of the battery 200 can be reduced to improve the temperature regulation effect.

The first flow section 113 and the second flow section 114 each include 4 branches 115, with each branch 115 being located on one side of a battery core 211. The width direction of the branches 115 is the same as the width direction of the battery cores 211, and the width of the battery cores 211 is defined as X and the width of the branches 115 as Y. Preferably, the width X of the battery cores 211 and the width Y of the branches 115 can be set to 0.5X≤Y<X. More preferably, the width X of the battery cores 211 and the width Y of the branches 115 can also be set to 0.5X≤Y≤0.6X.

From the above, by setting the width of the branches 115 to be more than or equal to half of the width of the battery cores 211, it is possible to obtain sufficient contact area between the branches 115 and the battery cores 211, and meanwhile ensure that there is enough heat exchange agent in the branches 115 so that the heat exchange with the battery cores 211 can be achieved quickly. Thus, the heat exchange agent flow-path 110 can meet the demand of the heat exchange power of the battery 200. In addition, by setting the width of the branches 115 to be smaller than the width of the battery cores 211, it is possible to prevent the width of the branches 115 from too large and exceeding the width of the battery cores 211, resulting in some of the heat exchange agent in the branches 115 not being able to participate in the heat exchange of the battery cores 211. Consequently, it is possible to avoid adding extra weight and wasting the heat exchange power of the heat exchange agent flow-path 110, thereby achieving light weight.

The heat exchange inlet 111 and the heat exchange outlet 112 are located above the first flow section 113 and the second flow section 114, thus avoiding collisions between the heat exchange inlet 111 and the heat exchange outlet 112 and their connected pipes and other parts with the objects under the battery pack 10 to reduce the chance of leakage due to collisions.

The heat exchange agent inlet 111 and the heat exchange agent outlet 112 are set horizontally in the form of a circular tube, the inflow cavity 116 and the outflow cavity 117 are trapezoidal in shape, the cross-sectional area of the inflow cavity 116 in the horizontal direction gradually increases from top to bottom, and the cross-sectional area of the outflow cavity 117 in the horizontal direction gradually decreases from bottom to top. The horizontal cross-sectional area of the inflow cavity 116 at the axis center of the heat exchange agent inlet 111 is equal to the vertical cross-sectional area perpendicular to the axis center of the heat exchange agent inlet 111. The horizontal cross-sectional area of the outflow cavity 117 at the axial center of the heat exchange agent outlet 112 is equal to the vertical cross-sectional area of the heat exchange agent outlet 112 perpendicular to the axial center of the heat exchange agent outlet 112. Accordingly, when the heat exchange agent flows through the heat exchange agent inlet 111, the heat exchange agent outlet 112, the inflow cavity 116, and the outflow cavity 117, the dimension of the space for the heat exchange agent to pass through remains the same, thus further reducing the pressure loss of the heat exchange agent to improve the heat exchange efficiency.

Note that the above is only a preferred embodiment of the present application and the technical principles used. One skilled in the art will understand that the present invention is not limited to the particular embodiments described herein, and that various obvious variations, readjustments and substitutions can be made by those skilled in the art without departing from the scope of protection of the present invention. Therefore, although the present application has been described in some detail with the above embodiments, the present invention is not limited to the above embodiments, but may include more other equivalent embodiments without departing from the conception of the present invention, all of which fall within the scope of protection of the present invention.

What is claimed is:

1. A battery pack comprising:
a housing and a battery provided in the housing, the housing provided with a heat exchange agent flow-path;
the battery comprising a battery module provided with at least two battery cores arranged in parallel;
the heat exchange agent flow-path comprising at least two branches, each branch being located at one side of each battery core;
wherein the width direction of the branches is the same as the width direction of the battery cores, and which the width of the battery cores is defined is X and the width of the branches is defined as Y, 0.5X≤Y<X.

2. The battery pack according to claim 1, wherein 0.5X≤Y≤0.6X.

3. The battery pack according to claim 1, wherein, within the battery module, each of the battery cores is arranged in parallel in its own width direction, and the length direction of the battery cores is the same as the length direction of the housing.

4. The battery pack according to claim 1, wherein when the height of the branches is defined as h, 2.1 mm≤h≤3.1 mm.

5. The battery pack according to claim 1, wherein the width of each branch is the same.

6. The battery pack according to claim 1, wherein the branches extend in the length direction of the battery cores.

7. The battery pack according to claim 1, wherein the heat exchange agent flow-path comprises a first flow section and a second flow section, the first flow section and the second flow section each comprising at least two branches, at least two of the branches being spaced apart and arranged in parallel.

8. The battery pack according to claim 7, wherein the housing is provided with a mounting position, the mounting position provided between the two branches, and the branches are provided with a deflecting bend, the deflecting bend being in the form of an arc to avoid the mounting position.

9. The battery pack according to claim 8, wherein the farther a branch is from the mounting position, the smaller the curvature of the deflecting bend in the branch is.

10. The battery pack according to claim 7, wherein the heat exchange agent flow-path has a heat exchange agent inlet and a heat exchange agent outlet, with one end of the first flow section communicated with the heat exchange agent inlet via an inflow cavity, and one end of the second flow section communicated with the heat exchange agent outlet via an outflow cavity.

11. The battery pack according to claim 10, wherein the heat exchange agent inlet is positioned further up than the first flow section, the inflow cavity having a gradually increasing cross-sectional area in the horizontal direction from top to bottom;
and/or the heat exchanging outlet is positioned further up than the second flow section, the outflow cavity having a gradually decreasing cross-sectional area in the horizontal direction from bottom to top.

12. The battery pack according to claim 7, wherein the first flow section and the second flow section form a U-shaped structure.

13. The battery pack according to claim 12, wherein the heat exchange agent flow-path further comprises:
a fluxion cavity communicating the other end of the first flow section with the other end of the second flow section, the first flow section and the second flow section together forming the U-shaped structure by being connected to the fluxion cavity;
the fluxion cavity having an inferior arc-shaped cross section in the horizontal direction on the side of the fluxion cavity away from the first flow section and the second flow section;
and/or the fluxion cavity having a trapezoidal cross-sectional shape in the horizontal direction and the bottom edge of the trapezoid provided on the side close to the first flow section and the second flow section and the top edge of the trapezoid away from the first flow section and the second flow section.

14. The battery pack according to claim 1, wherein the housing comprises:
a lower housing;
a base plate mounted on the lower housing, the heat exchanging flow-path formed between the base plate and the lower housing.

15. The battery pack according to claim 14, wherein the base plate is provided with at least two bumps protruding towards the lower housing; and the bumps are positioned in one-to-one correspondence with the battery cores.

16. The battery pack according to claim 14, wherein the lower housing is connected to the battery by means of a heat transfer adhesive.

17. The battery pack according to claim 14, further comprising:
a heat insulation layer provided on the side of the base plate away from the lower housing.

18. A vehicle comprising:
a bodywork, and a battery pack provided in the bodywork, the battery pack being the battery pack according to claim 1.

19. The vehicle according to claim 18, wherein the branches extend in the length direction of the vehicle.
